(19) United States
(12) Patent Application Publication
(10) Pub. No.: US 2007/0222408 A1
(43) Pub. Date: Sep. 27, 2007

(54) Simplified solid state electric motor drive technique

(76) Inventor: William Hughes, Rapid City, SD (US)

Correspondence Address: Gene R. Woodle, 3516 Woodle Drive, Rapid City, SD, 57702, US

(21) Appl. No.: 11/390,031

(22) Filed: Mar. 27, 2006

(51) Int. Cl. H02P 1/46

(52) U.S. Cl. 318/701

(57) ABSTRACT

A simplified solid state electric motor drive technique which may be used with a variable reluctance electric alternator or motor or similar device. The technique comprises the winding of the stator for each phase using two windings rather than the single, in series, winding of a conventional stator winding. A circuit is also provided in which a d-c power supply is connected through a switch to one stator winding and through a second switch to the second stator winding.

### BACKGROUND OF THE INVENTION

1. Field of the Invention

The present invention relates generally to electric power systems and more specifically to a stator winding technique with a simplified solid state electronic motor drive system which may be used with a variable reluctance electric alternator or motor or similar device.

2. Background Information

In the United States and throughout the world, millions of people use electric motors and alternators on a daily basis. Conventional motors and alternators have a variety of configurations, but ordinarily consist of a metal case (usually steel), a stator which is secured inside the case, and a rotor which turns on bearings mounted at the ends of the case. There are other electric motor configurations, but a great majority have this configuration. A stator usually includes a series of laminations with interior windings, usually of copper wire. The laminations are insulated from each other, are stacked, and are configured so as to hold the stator windings within the interior of the stator. Rotors have many configurations, but often have windings, laminations, magnets, commutators, or slip rings.

Electric motors may be either alternating current (a-c) or direct current (d-c) motors. In a-c motors, the stator can be wound with either single or multiple phase windings. The most common a-c motors are three phase with the windings interspersed and displaced 120 electrical degrees from each other. The basic design of the most common a-c motor in use today, the induction motor, has been known since the late 1800's and it is still considered by many to be the most economical to build for any given horsepower. In spite of its popularity, the induction motor has several serious drawbacks including: its starting torque is very low, it requires six to eight times its rated full load current to start, and speed control is difficult and requires considerable auxiliary equipment to be accomplished effectively. In addition, induction motors most often have a rotor generally consisting of stacked laminations in which several generally shorted aluminum windings are embedded.

Common d-c motors are more desirable for many applications than a-c induction motors, because they have a much higher starting torque and do not require the high starting current. However, the rotor in these d-c motors must have windings, commutation bars, and brushes to conduct the rotor current. This rotor configuration makes them expensive to manufacture, expensive to maintain, and limits the speed at which the rotor can turn and keep the windings safely embedded. Some d-c rotors have embedded magnets which reduces or eliminates some of these problems, but there is some degradation of performance.

For a variety of well established reasons, standard electric power operates at a frequency of 50 or 60 Hz. Because of their necessary configurations, the fastest conventional alternators can run for generating conventional electric power is 3,600 rpm at 60 Hz and 3,000 rpm for 50 Hz. If a device such as a modern turbine which may easily operate a speeds of around 50,000 rpm's are used to power such alternators, the speed must be mechanically reduced to either 3,600 rpm or 3,000 rpm to function properly. Furthermore, the operating speed of the turbine must be rigidly controlled for proper operation.

The variable reluctance electric power system solves a number of problems common to conventional motors and alternators and may be constructed either in a motor configuration or an alternator configuration. The rotor of this variable reluctance electric power system is solid and does not include windings, brushes, commutators, slip rings, laminations, or embedded magnets such as in more conventional a-c or d-c motors. For lower speed applications, the rotor may have the configuration of a hollow squirrel cage. A high speed drive device such as a turbine may be used without the necessity of using mechanical speed reduction in the alternator configuration. Even though the motor configuration is, basically, an a-c motor, it does not require the high start up current of a conventional a-c motor. Further this variable reluctance power system provides high starting torque. That is, this variable reluctance power system provides the benefits of both conventional a-c and d-c motors without having their inherent drawbacks.

The stator in a conventional electric motor or alternator may be wound in a variety of ways depending upon whether the device is single, double, or polyphase. Most common is probably the three phase arrangement. The vast majority of stators have a circular cross-section and include multiple tabs around which wire (usually copper) is wound. In a three phase motor or alternator the wire is wound around three adjoining tabs in one direction and then around the next three tabs in the opposite direction. That is, clockwise around three tabs and then counterclockwise around the next three tabs.

Conventional windings such as those described above can be driven by a solid state alternating current inverter which is actually a double pole double throw (DPDT) switch that must reverse itself every half cycle. In a polyphase device, every phase must have the equivalent of a DPDT switching system. Therefore, a three phase motor would require three DPDT switches. There are a number of ways in which the necessary DPDT switches required for stator windings may be built using power bipolar transistors (PBT's), Darlingtons, field effect transistors (FET's), insulated gate bipolar transistors (IGBT's), or silicon control rectifiers (SCR's). One common method of creating such a DPDT switching system is to connect four transistor to a d-c power source such that when two transistors are switched on the positive terminal of the d-c source is connected to the top of the stator winding and the negative terminal to the bottom of the winding. When the other two transistors are switched on, the polarity of the winding is reversed.

The above described DPDT switching system has a number of drawbacks. The first two transistors must be switched off and all minority carriers cleared before the second pair of transistors is turned on or a direct short occurs across the d-c supply. Therefore, often elaborate and expensive electronic control systems are necessary to prevent destruction of solid state switches in the event of inevitable current transients caused by such effects as lightning or other power line disturbances. Such DPDT switching systems also require that the transistor bases (or FET or IGBT gates) must all operate at different d-c power levels. Therefore, each must have a separate low power isolated d-c power supply. This necessitates up to eight isolated d-c supplies for a two phase system or up to twelve for a three phase system. Yet another difficulty presented by the conventional DPDT system described above is that four switching devices are required for each phase so that a two phase system requires up to eight devices and a three phase system requires up to twelve.

The stator winding technique combined with the simplified solid state switching system of the instant invention solves all of the above problems relating to a conventionally wound stator and solid state drive system as applied to the variable reluctance electric power system described above.

The ideal version of the instant invention solves these problems by preventing the possibility of a misfire triggering short. The ideal invention also should remove the need for separate isolated d-c power supplies for the trigger circuits. It should also reduce the number of switching devices for each phase. It should also be simple, reliable, inexpensive, and easy to operate and maintain.

### SUMMARY OF THE INVENTION

The variable reluctance electric power system described above may be operated as an alternator, as a motor, or in combination depending upon the associated auxiliary solid state equipment. The physical configuration of the alternator and the motor is basically the same. A case is provided which has the general shape of a hollow cylinder and which has bearings at either end. The case is made of a solid magnetic material and serves as the back iron to conduct magnetic flux longitudinally. Two stators fit within the case and are typically located at either end of the case. The stators are generally wound for three phase operation, although other phase windings could be used. A field winding which is simply a coil of insulated copper wire in the preferred embodiment, is located between the two stators. A magnetic steel rotor having a generally cylindrical shape rides on the bearings of the case. The rotor has a drive shaft which protrudes from one of the bearings and a ride shaft which rides on the other bearing.

The rotor has six lobes which run parallel to the longitudinal axis of the case and which protrude toward the case from the longitudinal axis of the rotor. These lobes are arrayed regularly around the circumference of the rotor. There is a critical air gap between the outer surface of the lobes of the rotor and the inner surface of the stators as well as a non critical air gap between the outer surface of the lobes and the field winding. This six lobe configuration is for operation with twelve pole stators. It should be understood that various other configurations may be used including: if the stators were wound as a four pole machine, there would be two lobes; for a six pole machine, three lobes; an eight pole machine, four lobes and so on.

A relatively small direct current is passed through the field winding. This has the effect of creating north poles at one end of the lobes of the rotor and south poles at the other ends. By any of a number of conventional means, the current directed through the field coil may easily be controlled and, thus, the strength of the magnetic field created at the lobes of the rotor may easily be controlled.

When the instant invention is being operated as an alternator, the drive shaft of the rotor may be connected to a prime mover such as a high speed turbine which may turn at any efficient speed, perhaps as high as 100,000 rpm. As with a conventional alternator, the rotation of the polarized lobes of the rotor induces an electric current in the windings of the two stators. The frequency of this current will vary, depending upon the speed of the rotor, but typically would be many times higher than the conventionally usable 60 Hz or 50 Hz.

Any of several conventional solid state solid state switching systems may be used to modify the frequency of the output from the alternator of the instant invention to change the frequency to any optimum usable frequency such as 50 Hz or 60 Hz. In working models of the instant invention, insulated gate bipolar transistors (IGBT's) and silicon control rectifiers (called SCR's) in a cycloconverter configuration have been used. Both of these systems are known in the prior art.

In its motor configuration, the instant invention is the same as in the alternator description above except that the drive shaft powers any operating unit such as a wheel, gear or any other device which might be driven by an electric motor. In addition, the motor includes a sensor which instantaneously sense position of the rotor. The sense signals are then used to trigger a solid state inverter system, the output frequency of which is thus exactly synchronized with the rotor. Thus, the rotor speed controls the frequency of the solid state switching system.

In summary, the variable reluctance electric power system has many aspects, but may be used as an alternator to generate high frequency alternating current from a high speed prime mover such as a turbine. The high frequency alternating current from the alternator may be converted by the switching system to provide a different frequency to operate the instant invention in its motor configuration.

The stators in the variable reluctance electric power system described above may be wound conventionally. That is, for a three phase system, with three tabs of the stator wound with copper wire in one direction and then with the next three tabs wound in series in the other direction. If the tabs were labeled 1, 2, 3, etc., tabs 1, 2, and 3 would be in one winding in, for instance, a clockwise direction and tabs 4, 5, and 6 would be wound in a counterclockwise direction. It should be understood that a second phase would be wound on tabs 2, 3, and 4 and tabs 5, 6, and 7. The third phase would be wound on tabs 3, 4, and 5 and tabs 6, 7, and 8 continuing around the circumference of the stator. As described above, each phase would be a DPDT switch which would include an isolated d-c power source and four switches which might be PBT's, Darlingtons, field effect transistors (FET's), insulated gate bipolar transistors (IGBT's), or, perhaps, silicon control rectifiers (SCR's).

Many of the problems associated with conventionally wound and driven stators as described above are solved by the use of the stator winding technique of the instant invention. Rather than being wound with a single winding for each phase in a three phase system, the stator winding technique of the instant invention uses two windings per phase. One winding would wrap tabs 1, 2, and 3 and then tabs 7, 8, and 9, etc. A second winding would wrap tabs 4, 5, and 6, and then tabs 10, 11, and 12, etc. The second phase windings would also include two coils with the first wrapping tabs 2, 3, and 4 and then tabs 8, 9, and 10 etc. The second phase winding would include two coils with the first wrapping tabs 3, 4, and 5 and then tabs 9, 10, and 11 etc. Any of the windings may be in either direction and do not have to have the clockwise/counterclockwise configuration of a conventionally wound stator. The stator configuration of the instant invention has several advantages over conventional stator windings. Only two switching devices are needed for each phase as opposed to four with a conventional winding. Only one d-c source is needed since no device isolation is necessary. Additionally, there is no possibility of a misfire triggering short and each coil switching circuit may be protected by a simple conventional fuse.

One of the major objects of the present invention is to provide a stator winding technique and solid state switching system which prevents the possibility of a misfire triggering short.

Another objective of the present invention is to provide a stator winding technique also removes the need for a separate isolated d-c power supply for each phase.

Another objective of the present invention to provide a stator winding technique and solid state switching system which also reduces the number of switching devices for each phase.

Another objective of the present invention is to provide a stator winding technique and solid state switching system which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a schematic drawing of a variable reluctance electric power system;

FIG. 2 is a sectional view the alternator aspect of a variable reluctance electric power system taken along line 2-2 of FIG. 1;

FIG. 3 is sectional view of the alternator aspect of a variable reluctance electric power system taken along line 3-3 of FIG. 1;

FIG. 4 is a partial view of a conventionally wound stator;

FIG. 5 is a partial view of a stator wound using the stator winding technique of the instant invention;

FIG. 6 is an end view of the sensor plate and sensor of a variable reluctance electric power system;

FIG. 7 is a diagram of a circuit of a DPDT switching system typical of that used with a conventionally wound stator; and

FIG. 8 is a diagram of a circuit of a switching system used with a stator wound with the stator winding technique of the instant invention.

### DESCRIPTION OF A PREFERRED EMBODIMENT

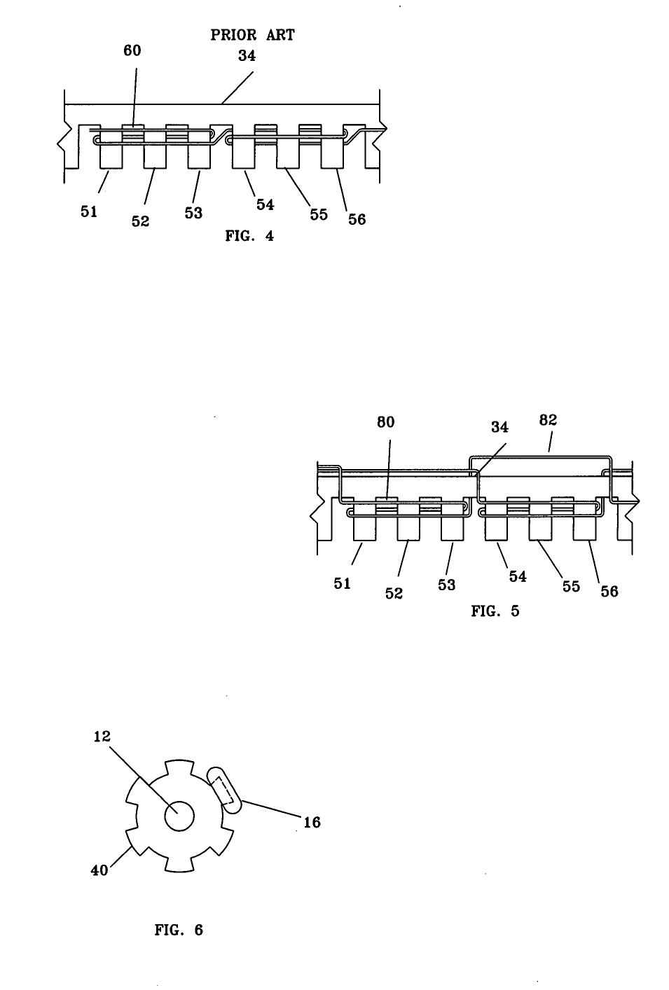

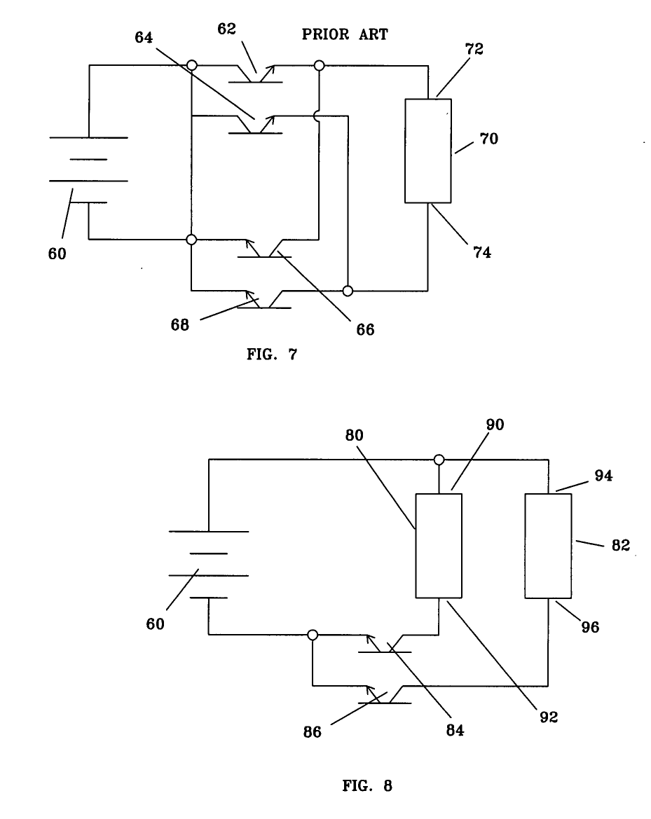

Referring to the drawings, FIGS. 1, 2, 3, and 6 there is shown a variable reluctance electric power system. FIG. 4 shows a partial view of a conventionally wound stator. FIG. 5 shows a partial view of a stator wound using the stator winding technique which embodies the instant invention. FIG. 7 shows the diagram of a typical DPDT switching system which might be used with one phase of a conventionally wound stator. FIG. 8 shows a diagram of a switching system which might be used with one phase of a stator wound using the stator winding technique of the instant invention.

Now referring to FIG. 1, a schematic drawing of a variable reluctance electric power system. A prime mover 2 could be any of a number of conventional power sources. For purposes of this discussion, the prime mover 2 will be assumed to be a turbine operating at any speed up to, or perhaps even beyond, 100,000 rpm. Said prime mover 2 is connected by an alternator drive shaft 4 to an alternator 6 of the instant invention. The output of the alternator 6 is a high frequency polyphase current which is routed to a solid state switching system 8. The switching system 8 uses any of several known solid state systems to change the frequency of the current output from said alternator 6. In creation and operation of experimental working models of the instant invention, insulated gate bipolar transistors (known as IGBT's) and silicon control rectifiers (known as SCR's) in a cycloconverter configuration were used for said switching system 8.

Still referring to FIG. 1, output from said switching system 8 powers a motor 10. The motor 10 turns a motor drive shaft 12 which, in turn, powers any operating unit 14. The operating unit 14 may be a wheel, for instance, or any of a number of devices which may ordinarily be operated by an electric motor. A sensor 16 senses the speed and location of the rotor (not shown in this Figure) which spins inside said motor 10. Output from the sensor 16 goes to a controller 18. A DC source 20 supplies variable direct current to field windings (not shown in this Figure) within said alternator 6 and said motor 10. The controller 18 controls both said switching system 8 and the DC source 20.

Referring now to FIG. 2, a sectional view of said alternator 6 of a variable reluctance electric power system taken along line 2-2 of FIG. 1 is shown. (This sectional view also shows a sectional view of said motor 10 with very few differences as described in detail below.) Said alternator 6 includes a case 22 having the general shape of a hollow cylinder with end caps holding a pair of conventional bearings 24. (Specialized bearings 24 may be appropriate for some applications.) The solid steel outer surface of the case 22 serves as the back iron 26. The back iron 26 provides part of the magnetic flux path indicated by arrow A. Said back iron 26 serves a purpose very similar to what is referred to as the back iron in conventional motors except that the flux path is longitudinal rather than perpendicular.

Still referring to FIG. 2, a rotor 28 is connected to said alternator drive shaft 4 and rides within said case 22 upon the bearings 24. Said alternator shaft 4 rides on one set of said bearings 24 and a second alternator shaft 30 rides on the other set of said bearings 24. The rotor 28 has the general shape of a solid cylinder, however, six equally spaced lobes 32 protrude outward from said rotor 28 and run the length of said rotor 28 along the longitudinal axis of said case 22. A pair of stators 34 having the general shape of a hollow cylinders are affixed to the inner surface of said case 22 such that there is an air gap 36 between the inner surface of the stators 34 and the outer surface of the lobes 32 on said rotor 28. The stators 34 are located at either end of said case 22. Except for their position and configuration, said stators 34 are wound for poly phase output and consist of conventional insulated steel laminations and windings. Production of similar stators is well known in the art. In the embodiment shown, said stators 34 are wound as for a twelve pole machine. Said stators 34 may be wound conventionally, but should be wound using the stator winding technique of the instant invention as described below. The flux path (as indicated by arrow A) is significantly different than in a conventional alternator or motor. This flux path may be described as from one end of said rotor 28, up through one of said stators 34, up into said case 22, longitudinally along said back iron 26, down through the other of said stators 34, through the other end of said rotor 28, and, longitudinally, along the length of said rotor 28. A field winding 38, having the general shape of a hollow cylinder, is affixed to the inner surface of said case 22 between said stators 34. The field winding 38 is a multi-layered solenoid coil.

Still referring to FIG. 2, a relatively small direct current is passed through said field winding 38 by said d-c source 20. According to well known principles, the direct current in said field winding 38 polarizes said lobes 32 in said rotor 28 creating north poles at one end of said lobes 32 and south poles at the other end. Said prime mover 2 turns said alternator drive shaft 4 at some appropriate speed which is often very high which, of course, turns said rotor 28 at the same speed. Again, according to principles well known in the art, the spinning of said rotor 28 with its polarized lobes 32 within said stators 34 generates a poly phase current within said stators 34 at a frequency determined by the speed of said prime mover 2. The strength of this generated current within said stators 34 depends upon the strength of the polarization of said lobes 32. The strength of this polarization is easily controlled by the direct current within said field winding 38.

Still referring to FIG. 2, said field winding 38 and said stators 34 are shown and described as being configured with two of said stators 34 near the ends of said case 22 with said field winding 38 in between. Various other configurations could be used without changing the spirit of the instant invention. For example, the device would still work (perhaps less efficiently) with a single stator 34 and a single field winding 38 or with a single stator 34 between two of said filed windings 38.

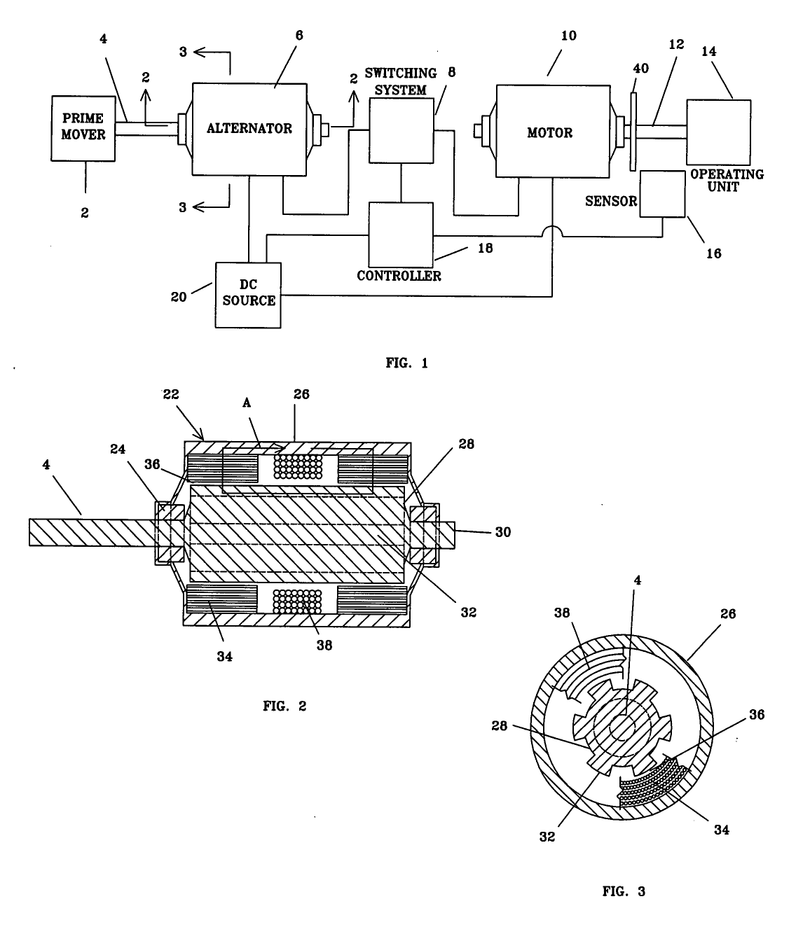

Referring now to FIG. 3, sectional view of the instant invention taken along line 3-3 of FIG. 1 is shown. This view better shows the configuration and relationship of some of the elements previously described. As may be clearly seen in this Figure, said field winding 38 encircles, but does not touch said rotor 28. This Figure, perhaps, also gives a better sense of the alignment and position of the windings in said stator 34. Note said air gap 36 between said stator 34 and the outermost surface of said lobes 32.

Referring again to FIG. 1, in the motor configuration of the instant invention, said motor 10 is nearly the same as said alternator 6. Physically, the only differences between said motor 10 and said alternator 6 are that what is shown in this Figure is said second alternator drive shaft 30 becomes said motor drive shaft 12 and there is a sensor plate 40 (see FIG. 8) affixed to said motor drive shaft 12. Said motor drive shaft 12 may be made longer or shorter to accommodate its connection to said operating unit 14.

Referring now to FIG. 6, an end view of the sensor plate 40 and said sensor 16 are shown. Said sensor plate 40 is a flat plate which complements the cross section of said rotor 28 (not shown in this Figure). That is, as said motor drive shaft 12 turns, the protrusions on said sensor plate 40 exactly mirror the speed and position of said lobes 32 (not shown in this Figure). In the preferred embodiment, said sensor 16 is a conventional infrared sensor and the protrusions of said sensor plate 40 periodically break the infrared beam. Because said sensor 16 does not rotate with said sensor plate 40, said sensor 16 can, effectively, sense the speed and position of said lobes 32 on said rotor 28. It will be understood that any of a variety of means for instantaneously detecting the position of said rotor 28 in said motor 10 could be used rather than the infrared sensor 16 or said sensor plate 40 described above. For example, magnetic or other mechanical means could be used.

Referring now to FIG. 4, a partial view of a conventionally wound stator is shown. Said stator 34 is shown as being flat for simplicity, but it will be understood that the stator is circular in cross-section. Said stator 34 includes a plurality of tabs and the tabs are found around the entire circumference of said stator 34. For ease of explanation, the tabs are labeled in this figure as tabs 51 through 56. Said stator 34 shown is wound for a three phase system, but it will be understood that other phase configuration are wound similarly. A stator wire 60 is wound around three tabs, for instance, tabs 51, 52, and 53 such that the winding encircles all three tabs in a single loop. The stator wire is then wound, in series, around the next three tabs, for instance, tabs 54, 55, and 56, in the same manner, but in the opposite direction. That is, if tabs 51, 52, and 53, were wound in a clockwise direction; tabs 54, 55, and 56 would be wound in a counter clockwise direction. A second phase winding would be wound similarly, but rather than encircling tabs 51, 52, and 53, would encircle tabs 52, 53, and 54 etc. A third phase winding would be wound similarly, but would encircle tabs 53, 54, and 55 etc.

Referring now to FIG. 7, a diagram of a circuit of a DPDT switching system typical of that used with a conventionally wound stator is shown. Conventional windings such shown in FIG. 4 above are driven by a solid state alternating current inverter which is actually a double pole double throw (DPDT) switch that must reverse itself every half cycle. In a polyphase device, each phase must have the equivalent of a DPDT switching system. Therefore, a three phase motor would require three DPDT switches. There are a number of ways in which the necessary DPDT switches required for stator windings such as those shown in FIG. 4 may be built using power transistors (PBT's), Darlingtons, field effect transistors (FET's), insulated gate bipolar transistors (IGBT's), silicon control rectifiers (SCR's). One common method of creating such a DPDT switching system is to connect four transistors to a d-c power source as is shown in this figure. Any of the described switching devices may be used and transistors are used in this example. A stator d-c power source 60 is connected to four transistor such that when one pair of transistors 62 and 68 are switched on the positive terminal of the stator d-c power source 60 is connected to one end 72 of one phase winding 70 of said stator 34 and the negative terminal of said stator d-c power source 60 is connected to the other end two 74 of the phase winding 70. When the other pair of transistors 64 and 66 are switched on and transistors 62 and 68 are switched off, the polarity is reversed and the positive terminal of said stator d-c power source 60 is connected to end two 74 of the phase winding 70 and the negative terminal is connected to end 72. It will be understood that each phase of the motor requires a similar circuit and isolated d-c power supply.

Referring now to FIG. 5 a partial view of a stator wound using the stator winding technique of the instant invention is shown. Rather than having a single wire as in the conventionally wound stator as described in FIG. 4 above, the stator is wound with two wires for each phase. Stator wire one 80 is wound around tabs 51, 52, and 53 and then around tabs 57, 58, and 59 etc. (not shown). Stator wire two 82 is wound around tabs 54, 55, and 56, and then around tabs 60, 61, and 62 etc. (not shown). Each phase would have two stator wires are described above. The second phase would have a stator wire one 80 wound around tabs 52, 53, and 54, and then 58, 59, and 60 etc. and a stator wire two 82 wound around tabs 55, 56, and 57 and then 61, 62, and 63 etc. The third phase would have a stator wire one 80 wound around tabs 53, 54, and 55 and then 59, 60, and 61 etc. and a stator wire two 82 wound around tabs 56, 57, and 58, and then 62, 63, and 64 etc. Contrary to a conventionally wound stator, it makes no difference in what direction the stator wires are wound. In other respects the stator is wound and laminated similarly to a conventionally wound stator.

Referring now to FIG. 8, a diagram of a circuit of a switching system used with a stator wound with the stator winding technique of the instant invention is shown. The circuit includes a stator d-c power source 60 which is connected to a transistor 84 such that when the transistor 84 is switched on the positive terminal of the stator d-c power source 60 is connected to one end 90 of said stator wire one 80 and the negative terminal of said stator d-c power source 60 is connected to the other end, end two 92, of said stator wire one 80. When said transistor 84 is switched off and transistor 86 is switched on the positive terminal of said stator d-c power source 60 is connected to one end 94 of said stator wire two 82 and the negative terminal of said stator d-c power source 60 is connected to the other end, end two 96, of said stator wire two 82. It will be understood that PBT, Darlington, FET, IGBT, and SCR switches could be used. Each phase would require a similar circuit, but a singe stator d-c power source could be used. Each circuit could be protected by the addition of a simple conventional fuse.

In operation the variable reluctance electric power system described above works as follows.

In the example, said prime mover 2 turns said alternator shaft 4 and said rotor 28 at perhaps 50,000 rpm. (It should be understood that the same operation could be achieved using virtually any prime mover operating at virtually any speed.) A small direct current from said DC source 20 is applied to said field winding 38 which effectively polarizes said lobes 32 creating north and south poles in said lobes 32. According to principles well known in the field, the rotational movement of polarized lobes 32 induces an alternating current in said stators 34 at a frequency determined by the speed of said rotor 28. The strength of the current induced in said stators 34 may be controlled by controlling the direct current from said d-c source 20. That is, the stronger the polarity induced in said lobes 32 by that direct current, the stronger the current induced in said stators 34.

The outputs of corresponding phases of both of said stators 34 may be connected either in parallel or in series to give a conventional poly phase output. For some applications, it may be appropriate to keep the phases separate rather than connect them in a conventional Y or DELTA to minimize iron losses in the machines. This is particularly true when, for a variety of reasons, it is desired to have wave form outputs other than sine waves. The instant invention has been consistently described as being a poly phase machine and said stators 34 may be wound to create nearly any appropriate phase configuration.

A poly phase alternating current from said stators 34 is directed to said switching system 8. Using any of a number of well known conventional components and solid state systems, the frequency of this current is changed by said switching system 8 to power said motor 10. Said motor 10 is configured much the same as said alternator 6 and said motor 10 operates, basically, in reverse of said alternator 6. The current from said switching system 8 flows through said stators 34 and said lobes 32 are also polarized by direct current from said d-c source 20 flowing through said field winding 38. Again, according to well known principles, said rotor 28 spins and turns said motor drive shaft 12 which, in turn turns said operating unit 14 (in the example, the drive wheel of a vehicle). The speed and torque at which said rotor 28 and said motor drive shaft 12 turn are controlled by the amount of direct current directed to said field winding 38 from said DC source 20. It may be understood that it would be a relatively simple matter to split off sufficient direct current from said switching system 8 to supply power to said d-c source 20.

Said sensor 16 senses the position of said lobes 32 is said motor 10 and sends a signal to the controller 18. Said controller 18 controls said switching system 8 such that the frequency of the alternating current from said switching system 8 matches the speed of said rotor 28 in said motor 10. Said controller 18 also controls the amount of current from said d-c source 20 which flows to said filed windings 38 in said alternator 6 and said motor 10. In the preferred embodiment said controller 18 includes a simple rheostat which increases or decreases the d-c current to said field windings 38 in said alternator 6 and said motor 10. Said controller 18 further includes a conventional open loop operational amplifier which receives the signals from said sensor 16 and converts the signals to clean, square wave signals. That is, the signals are converted to what may be considered either an on or off state. Thus, said controller 18 uses these square wave signals to drive the SCR's or IGBT's in said switching system 8.

In the example described above, a turbine powered vehicle, the speed and torque of the drive wheel (said operating unit 14) are controlled by said controller 18. That is, by increasing or decreasing the d-c current to said field winding 38 in said motor 10, the speed and torque of the drive wheel are increased or decreased. Using signals received from said sensor 16, said controller 18 further controls said switching system 8 to automatically insure that the frequency of the current into said motor 10 is exactly synchronized with said rotor 28 in said motor 10. It should be understood that the same process could be applied to virtually any operating unit 14 and not just to a vehicle drive wheel.

Because the polarization of said rotor 28 is accomplished by said field windings 38 rather than by the induction method used in conventional induction motors, the high starting current requirement of those induction motors does not occur with said motor 10 of the instant invention.

Although described above as being a variable reluctance electric power system with said alternator 6 being coupled with said motor 10, said alternator 6 and said motor 10 could also be used separately where appropriate. For example, said alternator 6 could be used to supply electricity to a power grid with the output frequency changed as necessary by said switching system 8.

It should be noted that in the stator winding technique of the instant invention, the current through each of the stator windings (stator wire 80 and stator wire 82) is in one direction. The current does not reverse as in the conventionally wound stator shown in FIG. 4 and with the circuit shown in FIG. 7. Therefore, the stator winding technique of the instant invention would not work properly in a conventional electric motor or alternator, but would only work in the variable reluctance electric power system described here or in a similar device.

All elements of the variable reluctance electric power system are made of steel except for those described below, but other material having similar strength, and magnetic properties could be used. Said case 22 and said rotor 28 are made from 4140 alloy steel, but any solid magnetic material having similar characteristics such as 4340 alloy steel could be used.

While preferred embodiments of this invention have been shown and described above, it will be apparent to those skilled in the art that various modifications may be made in these embodiments without departing from the spirit of the present invention. That is, the device could be used for a wide variety of purposes either in combination or separately.

I claim:

1. A simplified solid state electric motor drive technique for use with a variable reluctance electric alternator or motor, in which such alternator or motor includes at least one stator wound poly phase and in which the stator has a plurality of tabs upon which stator windings may be wound comprising:
(1) a stator winding one and a stator winding two for each phase of said alternator or motor such that stator winding one is wound about the appropriate series of tabs of the stator and stator winding two is wound about the next appropriate series of tabs of the stator and thus alternating until all of the tabs are wound; and
(2) a circuit for each pair of stator windings for each phase in which the circuit includes a d-c source and a switch one and a switch two such that when switch one is on and switch two is off d-c power is supplied to said stator winding one and not to said stator winding two and when said switch one in off and said switch two is on d-c power is supplied to said stator winding two and not to said stator winding one.

2. A simplified solid state electric motor drive technique for use with a variable reluctance electric alternator or motor, in which such alternator or motor includes at least one stator wound poly phase:
(1) a stator with two windings for each phase such that each winding has only one solid state switch; and
(2) a d-c power supply which can operate all gates of all the solid state switches without the necessity for isolated d-c power supplies for each switch.
